(19) United States
(12) Patent Application Publication
(10) Pub. No.: US 2026/0328245 A1
(43) Pub. Date: Oct. 22, 2026

(54) HIGH-LOAD-BEARING AND WEAR-RESISTANT SELF-LUBRICATING PROTECTIVE COATING, PREPARATION METHOD THEREFOR AND USE THEREOF

(71) Applicant: INSTITUTE OF NEW MATERIALS GUANGDONG ACADEMY OF SCIENCES, Guangzhou (CN)

(72) Inventors: Min Liu, Guangzhou (CN); Shuangjian Li, Guangzhou (CN); Chunming Deng, Guangzhou (CN); Jie Mao, Guangzhou (CN); Chao Wang, Guangzhou (CN); Ke Huang, Guangzhou (CN); Huanxiang Lv, Guangzhou (CN)

(21) Appl. No.: 19/358,466

(22) Filed: Oct. 15, 2025

(30) Foreign Application Priority Data
Apr. 22, 2025 (CN) 202510503114.6

(51) Int. Cl. F16C 33/04; F16C 32/04

(52) U.S. Cl. CPC F16C 33/043; F16C 32/0406; F16C 2202/04; F16C 2202/10; F16C 2202/50; F16C 2206/42; F16C 2223/02; F16C 2223/42

(57) ABSTRACT

A high-load-bearing and wear-resistant self-lubricating protective coating, a preparation method therefor. and use thereof are provided. The high-load-bearing and wear-resistant self-lubricating protective coating includes a metal transition layer and a ceramic material layer provided in sequence, where the ceramic material layer is provided with a plurality of pores, the porosity of the ceramic material layer is in gradient increasing distribution from inward to outward along a surface normal direction of the self-lubricating protective coating, and the pores of the ceramic material layer are filled with lubricating oil.

### CROSS-REFERENCE TO RELATED APPLICATION

The present disclosure claims the priority to Chinese patent application with the filing number 202510503114.6 filed on Apr. 22, 2025 with the Chinese Patent Office, the contents of which are incorporated herein by reference in entirety.

### TECHNICAL FIELD

The present disclosure belongs to the technical field of self-lubricating protective coatings, and specifically relates to a high-load-bearing and wear-resistant self-lubricating protective coating, a preparation method therefor and use thereof.

### BACKGROUND ART

Magnetic bearings are a new type of high-performance bearing. Compared with conventional ball bearings, sliding bearings and oil film bearings, magnetic bearings operate without mechanical contact, can allow a rotor to achieve very high rotational speeds, and have advantages such as minimal mechanical wear, low energy consumption, low noise, long service lifetime, no need for lubrication, and no oil pollution. They are particularly suitable for high-speed, vacuum, ultra-clean and like special environments, widely applicable in fields such as machining, turbomachinery, aerospace, vacuum technology, and rotor dynamic characteristic identification and testing, and are generally acknowledged as highly promising novel bearings. Herein, an auxiliary bearing unit is an essential component in the operation of magnetic bearings. When the magnetic bearings experience faults such as sudden power loss, rotor instability, and overload or are subjected to impact load, the rotor of the magnetic bearing is in contact with an inner ring of the auxiliary bearing unit, and the auxiliary bearing unit supports the rotor to rotate and bears the load, so as to prevent friction between a stator and the rotor of the magnetic bearing. If the auxiliary bearing unit lacks high-load bearing and self-lubricating functions, when the magnetic bearings experience a sudden fault such as power loss, rotor instability, or overload of the magnetic bearing or are subjected to impact load, the rotor will lose a levitated state, thus causing collision and wear between a shaft and the bearing, and damaging the bearing and other related equipment. Especially under high speeds and high loads, severe wear occurs between the rotor shaft of the bearing and a bushing of the auxiliary bearing unit (or auxiliary bearing), leading to dynamic imbalance and ultimately causing an entire magnetic bearing system to fail. Wear pictures are shown in FIG. 1.

At present, approaches to solve the above wear problem in the prior art are as follows.
1. By providing pores in a material of the body of a part (for example, a contact area of the auxiliary bearing unit with the shaft) and then impregnating with oil, porous oil-containing lubrication is formed. However, on the one hand, porous metal is reduced in strength, and fails to bear high loads; and on the other hand, an effect of frictional force will cause metal adhesion, blocking further seepage of lubricating oil within the pores.
2. Polymer-based oil-retaining bearings, represented by porous polyimide, are adopted. A monolithic porous polyimide bearing material is prepared, and then impregnated with lubricating oil to achieve lubrication. However, as polyimide polymer material is a primary load-bearing material, it can only withstand low loads, but fails to bear medium to high loads. During practical testing, a drop will directly cause complete breakage of polyimide bearings.
3. Porous metal-based oil-retaining bearings are adopted. A monolithic porous metal auxiliary bearing material is directly prepared, and then impregnated with lubricating oil to realize lubrication. However, on the one hand, porous metal is reduced in strength, and fails to bear high loads; and on the other hand, an effect of frictional force will cause metal adhesion, blocking further seepage of the lubricating oil within pores.
4. A high-strength and low-friction coefficient liner made from an organic polymer material, such as a PTFE fiber fabric liner, is embedded inside the auxiliary bearing unit. Sliding friction between the shaft and the liner can protect the stator and the rotor of the magnetic bearing from collision. Grooves provided on an inner side of a support ring can be configured to enhance contact strength between the liner and the support ring, and improve reliability of the auxiliary bearing. However, under repeated external friction, fatigue phenomena will occur, causing fiber fracture; the fibers are prone to being pulled out, leading to fabric structure loosening; slight cracking occurring on a surface layer of the fiber causes the fiber to become brittle; and frictional heat will melt or plastically deform the fiber, accelerating fabric wear.
5. A wear-resistant lubricating thin film, such as MoS₂, is applied to an interior of the auxiliary bearing unit. However, MoS₂ starts to oxidize at 200° C. (temperature will exceed 200° C. during friction), causing lubricity to degrade sharply, and even generating abrasive particles that negatively affect the auxiliary bearing unit. Moreover, a usage effect in a humid atmosphere is unfavorable because molybdenum disulfide is susceptible to moisture, which affects the lubricating effect thereof. Finally, as the coating is extremely thin (<10 micrometers), an “eggshell” effect is particularly pronounced, making the film layer prone to fracture under high impact. Magnetic bearings in steam turbine sets operate in high-temperature saturated steam, and temperature of the auxiliary bearing unit will exceed 200° C. under high-speed friction after the rotor drops, which cannot reliably meet conditions of repeated use.

It should be noted that the contents in this section of the present disclosure merely provide background art related to the present disclosure but do not necessarily constitute the prior art or publicly known technology.

### SUMMARY

An objective of the present disclosure is to provide a high-load-bearing and wear-resistant self-lubricating protective coating, a preparation method therefor and use thereof, so as to overcome the defects in the prior art that wear-resistant lubricating coatings for large-scale, high-speed magnetic bearing auxiliary units still exhibit severe wear between a magnetic bearing and a bushing of the auxiliary bearing unit under high speeds and high loads, and they fail to meet requirements of high loads, high impacts and repeated use under such conditions. The self-lubricating protective coating of the present disclosure offers high bonding strength with a substrate. It can achieve excellent wear resistance and material compatibility, and can withstand 10 or more impacts of the magnetic bearing under high speeds and high loads with virtually no wear on the shaft or the auxiliary bearing itself. Moreover, long-term service of the self-lubricating protective coating is ensured, and toughness, microhardness, and long-term lubricity of the self-lubricating protective coating are guaranteed, enabling it to be reused multiple times.

In order to achieve the above objective, in the first aspect, the present disclosure provides a high-load-bearing and wear-resistant self-lubricating protective coating, including a metal transition layer and a ceramic material layer provided in sequence, where the ceramic material layer is provided with a plurality of pores, the porosity of the ceramic material layer is in gradient increasing distribution from inward to outward along a surface normal direction of the self-lubricating protective coating, and the pores of the ceramic material layer are filled with lubricating oil.

In some preferred embodiments of the present disclosure, the porosity of the ceramic material layer is 5%-35%, and/or the ceramic material layer is oxide ceramic.

In some preferred embodiments of the present disclosure, an increase in the amplitude of the porosity of the ceramic material layer satisfies that along the surface normal direction of the self-lubricating protective coating, an absolute value of a difference in the porosity between two different adjacent gradients is 5%-15%.

In some preferred embodiments of the present disclosure, a penetration depth of the lubricating oil within the ceramic material layer is 60%-100% of a thickness of the ceramic material layer.

In some preferred embodiments of the present disclosure, the penetration depth of the lubricating oil within the ceramic material layer is 50-300 μm.

In some preferred embodiments of the present disclosure, a thickness of the ceramic material layer is 50-300 μm, and a thickness of the metal transition layer is 20-60 μm.

In some preferred embodiments of the present disclosure, a thickness ratio of the ceramic material layer to the metal transition layer is (2.5-5):1.

In some preferred embodiments of the present disclosure, a material of the ceramic material layer includes at least one selected from alumina, titania, zirconia, and chromia; and/or a material of the metal transition layer is selected from MCrAlY alloy and/or an aluminum alloy, where M in the MCrAlY alloy is Ni, Co, Fe or any combination thereof, and the aluminum alloy includes at least one selected from nickel-aluminum alloy, nickel-chromium-aluminum alloy, and nickel-chromium alloy.

Furthermore, the ceramic material layer is preferably selected from either a mixture of alumina and titania or a mixture of chromia and titania.

In some preferred embodiments of the present disclosure, surface roughness Ra of the self-lubricating protective coating is lower than 0.5 μm.

In some preferred embodiments of the present disclosure, the average microhardness of the self-lubricating protective coating is 400-900 HV0.3, and/or the self-lubricating protective coating is capable of resisting 10 or more impacts under conditions where a magnetic bearing weight is not less than 1,000 kg and a rotational speed is not less than 5,000 rpm.

In the second aspect, the present disclosure provides a preparation method for a high-load-bearing and wear-resistant self-lubricating protective coating, including steps as follows:
S1, depositing a metal transition layer on a working surface of a substrate to be coated;
S2, preparing a ceramic material layer having a plurality of pores outside the metal transition layer, and controlling porosity of the ceramic material layer to be in gradient increasing distribution from inward to outward along a surface normal direction of the self-lubricating protective coating; and
S3, filling the pores of the ceramic material layer with lubricating oil.

In some preferred embodiments of the present disclosure, the ceramic material layer is prepared using a thermal spray technique, where conditions of the thermal spraying include a spraying distance of 80-130 mm, a current of 450-650 A, a voltage of 60-80 V, and a substrate temperature of 100-150° C.

In some preferred embodiments of the present disclosure, the lubricating oil is filled using an impregnation process, where conditions of impregnation include an impregnation temperature of 50-200° C., a pressure of 1-100 Pa, a single impregnation duration of 5-30 min, and 1-5 times of impregnation.

In some preferred embodiments of the present disclosure, the preparation method further includes after preparing the ceramic material layer in S2, further performing grinding to make a final surface roughness Ra of the coating lower than 0.5 μm and then performing S3.

In the third aspect, the present disclosure provides a high-load-bearing and wear-resistant self-lubricating protective coating that is prepared using the method described in the second aspect.

In the fourth aspect, the present disclosure provides a magnetic bearing, including an auxiliary bearing unit, where the high-load-bearing and wear-resistant self-lubricating protective coating of the first aspect, or the high-load-bearing and wear-resistant self-lubricating protective coating of the third aspect, is provided on an inner ring and/or an end surface of a contact area of the auxiliary bearing unit with a shaft.

### Beneficial Effects

Through the above technical solutions of the present disclosure, particularly by providing the ceramic material layer with specific gradient increasing pore distribution and filling the pores with the lubricating oil, the specifically structured ceramic material layer can enhance the wear resistance thereof, and also can achieve the lubricating effect and bear high impacts and high loads. Moreover, the metal transition layer is provided between the substrate (e.g., a working surface of a dense metal part) and the ceramic material layer. The metal transition layer can ensure excellent bonding strength between the self-lubricating protective coating and the substrate, and the coefficient of thermal expansion and mechanical properties of the metal transition layer match those of the ceramic material layer, thereby achieving an excellent wear-resistant effect and material compatibility. Thus, high-speed, high-load impacts can be tolerated with virtually no wear; the long-term service of the self-lubricating protective coating is ensured; and the toughness, microhardness, and long-term lubricity of the self-lubricating protective coating are maintained.

Herein, the pores of the ceramic material layer in the specific gradient pore distribution of the present disclosure are filled with the lubricating oil, so as to form a porous oil-retaining coating. The gradient pore distribution can achieve synergistic optimization of mechanical properties and oil storage capacity, specifically embodied in that: 1) An inner layer is a low-porosity region; a dense structure endows the coating with high bonding strength (>40 MPa) and high compressive strength (>1.5 GPa), effectively resists shear stress at a substrate-coating interface, and prevents delamination of the coating. 2) An outer layer is a high-porosity region: high interconnected porosity provides a large oil storage capacity and significantly prolongs a lubricating oil supplying cycle. 3) Gradient transition layer: continuous gradient variations in porosity can eliminate abrupt interface changes, suppress stress concentration, and improve the impact resistance of the coating. Cross-scale structural design of “sparse exterior and dense interior” of the gradient porosity distribution breaks through an inherent limitation of “oil storage-strength” conflict in conventional uniformly porous coatings, and realizes integrated multifunctionality of on-demand lubricating oil release, gradient stress dissipation, environmental adaptability and the like, so that the porous oil-retaining coating can maintain its usage effect for a long time in vacuum, high-humidity, high-temperature (different types of lubricating media can be selected according to environmental changes) and like environments. The self-lubricating protective coating formed by the porous oil-retaining coating and the metal transition layer has certain toughness and damage tolerance, and will not generate damages such as obvious cracks or delamination under high-speed impacts of the shaft. Upon impact, the internal lubricating oil is extruded out and provides a friction-reduction effect. The lubricating oil can be used in the above environments for a long time without failure, and the self-lubricating protective coating can tolerate 10 or more drop impacts at various angles under an ultra-high load of 1,000 kg and an ultra-high rotational speed of 5000 rpm.

The method for preparing a self-lubricating protective coating described in this disclosure is straightforward, easy to implement, and highly practical. The ceramic material layer is preferably prepared through the thermal spraying technique, which is more beneficial to ensuring the high bonding strength of the self-lubricating protective coating. Moreover, the gradient pore distribution of the ceramic material layer allows easy regulation and control. Different types of lubricating media can be chosen as the lubricating oil based on environmental variations to meet various application scenarios, while also ensuring long-term effectiveness in different environments.

### BRIEF DESCRIPTION OF THE DRAWINGS

In order to illustrate technical solutions of embodiments of the present disclosure more clearly, drawings that need to be used in the embodiments will be briefly introduced below. It should be understood that the drawings merely show some embodiments of the present disclosure, and thus should not be considered as a limitation to the scope, and those ordinarily skilled in the art still could obtain other relevant drawings according to the drawings, without using any inventive efforts.

FIG. 1 shows pictures of severe wear of a bushing after a single drop test of a levitated rotor motor under a high speed and a high load in the prior art.

FIG. 2 shows pictures of a bushing still without obvious wear after ten drop tests under a high speed and a high load when a levitated rotor motor in Example 1 of the present disclosure adopts a self-lubricating protective coating.

FIG. 3 is an optical micrograph of the microstructure of the self-lubricating protective coating of Example 1 of the present disclosure.

FIG. 4 shows surface topography SEM images and elemental distribution diagrams of the coating obtained after impregnating a ceramic material layer of Example 1 with lubricating oil.

FIG. 5 shows cross-sectional topography SEM images and elemental distribution diagrams of the coating obtained after impregnating a ceramic material layer of Example 1 with lubricating oil.

FIG. 6 presents a graph comparing the coefficients of friction for both a pure ceramic coating and the self-lubricating protective coating described in this disclosure.

FIG. 7 is a graph of test results of coefficients of friction of the self-lubricating protective coating of the present disclosure after 10 h of long-term friction.

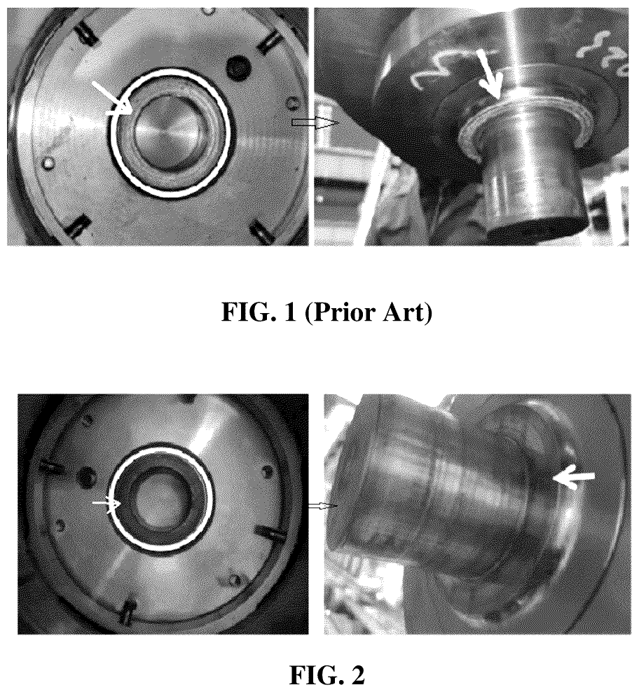

### DETAILED DESCRIPTION OF THE EMBODIMENTS

In the present disclosure, the terms “first” and “second” are merely used for descriptive purposes but should not be construed as indicating or implying importance in the relativity or implicitly indicating the number of a related technical feature. Thus, defining a feature with “first” or “second” may explicitly or implicitly mean that one or more such features are included. In the description of the present disclosure, “a plurality of” means two or more, unless otherwise explicitly defined.

In the present disclosure, unless otherwise explicitly specified and defined, a first feature being “on” or “under” a second feature may mean that the first feature is in direct contact with the second feature, or the first feature is in indirect contact with the second feature via an intermediary. Moreover, a first feature being “on”, “over” and “above” a second feature may include a case where the first feature is directly above or obliquely above the second feature, or merely indicates that the first feature is at a horizontal height higher than that of the second feature. Moreover, a first feature being “under”, “beneath” and “below” a second feature may include a case where the first feature is directly below or not directly below the second feature, or merely indicates that the first feature is at a horizontal height lower than that of the second feature.

Endpoints and any value of ranges disclosed herein are not limited to precise ranges or values, and these ranges or values should be understood as encompassing values close to these ranges or values. For numerical ranges, endpoint values of various ranges can be combined with each other, endpoint values of various ranges and individual point values can be combined with each other, and individual point values can be combined with each other to obtain one or more new numerical ranges, which numerical ranges should be construed as being specifically disclosed herein. Herein, the terms “optional” and “optionally” both mean possibly including or not (or possibly being present or possibly being not present).

In the present disclosure, a direction close to a metal transition layer and an inner substrate thereof is defined as inward, and an opposite direction as outward.

In the first aspect, the present disclosure provides a high-load-bearing and wear-resistant self-lubricating protective coating, including a metal transition layer and a ceramic material layer provided in sequence. The ceramic material layer is provided with a plurality of pores, the porosity of the ceramic material layer is in gradient increasing distribution from inward to outward along a surface normal direction of the self-lubricating protective coating, and the pores of the ceramic material layer are filled with lubricating oil. The ceramic material layer with the porosity in gradient increasing distribution has a relatively strong bonding capacity with the metal transition layer, and coupled with gradient distribution of the lubricating oil, the present disclosure breaks through an inherent limitation of the “oil storage-strength” conflict in conventional uniformly porous coatings, and realizes integrated multifunctionality of on-demand lubricating oil release, gradient stress dissipation, environmental adaptability and the like.

In some preferred embodiments of the present disclosure, the porosity of the ceramic material layer is 5%-35%. Employing the ceramic material layer with the porosity in a suitable small range is more beneficial to realize synergistic optimization of mechanical properties and oil-storage capacity.

The porosity of the ceramic material layer being in gradient increasing distribution from inward to outward along the surface normal direction of the self-lubricating protective coating in the present disclosure means that in the direction from inward to outward along the surface normal direction of the self-lubricating protective coating, the porosity of the ceramic material layer may show an overall increasing trend. For example, the porosity may increase in a gradient stepwise by thickness or continuously increase in a thickness direction. For instance, the porosity of the ceramic material layer within a certain thickness may vary (gradually increase) or remain unchanged, and when the porosity is unchanged, the porosity of the ceramic material layer in certain adjacent thicknesses is relatively increased, and an increased amplitude can be either uniform or non-uniform. Uniform increase in porosity is preferred.

In some preferred embodiments of the present disclosure, the increased amplitude of the porosity of the ceramic material layer satisfies that along the surface normal direction of the self-lubricating protective coating, an absolute value of a difference in porosity between two different adjacent gradients is 5%-15%, preferably 5%-10%, for example, it may be specifically 5%, 6%, 7%, 8%, 9%, 10%, 12%, or 15% and in a range between any two numerical values. Using the ceramic material layer with a suitable amplitude-increasing structure is more beneficial to improve impact resistance of the coating.

In some preferred embodiments of the present disclosure, a penetration depth of the lubricating oil within the ceramic material layer is 60%-100% of a thickness of the ceramic material layer; for example, it may be specifically 60%, 65%, 70%, 75%, 80%, 85%, 90%, 95%, 100% and in a range between any two numerical values, for example, further preferably 85%-100%. The present disclosure uses the lubricating oil with a suitable permeation depth ratio, being more beneficial for long-term lubrication.

In some preferred embodiments of the present disclosure, the penetration depth of the lubricating oil within the ceramic material layer is 50-300 μm.

Types of lubricating oil of the present disclosure include, but are not limited to, at least one of mineral lubricating oil, biological lubricating oil, and synthetic lubricating oil (such as methyl silicone oil), and it can be selected according to practical application scenarios with reference to corresponding types of lubricating oils in the prior art. All of them can be used in the present disclosure, so as to satisfy lubrication requirements in different application scenarios.

In some preferred embodiments of the present disclosure, the thickness of the ceramic material layer is 50-300 μm, preferably 100-300 μm.

Preferably in the present disclosure, a thickness of the metal transition layer is 20-60 μm.

In some preferred embodiments of the present disclosure, a thickness ratio of the ceramic material layer to the metal transition layer is (2.5-5):1, more preferably (2.5-3.0):1. The present disclosure uses the ceramic material layer and the metal transition layer in an appropriate thickness ratio, which is more beneficial to mitigate the thermal stress of the metal transition layer and the ceramic material layer while ensuring the coating's impact resistance.

In some preferred embodiments of the present disclosure, the ceramic material layer is oxide ceramic.

In some preferred embodiments of the present disclosure, a material of the ceramic material layer includes at least one selected from alumina, titania, zirconia, and chromia.

Further preferably, a material of the ceramic material layer is selected from a mixture of alumina and titania or a mixture of chromia and titania. Adopting this preferred solution enhances the coating's hardness and toughness.

Further preferably, a mass proportion of titania in the ceramic material layer is 3-40 wt %, which is more beneficial to improve hardness and toughness of the coating.

In some preferred embodiments of the present disclosure, a material of the metal transition layer is selected from MCrAlY alloy (where Mis Ni, Co, Fe or any combination thereof) and/or an aluminum alloy. Additionally, the aluminum alloy includes at least one of the following: nickel-aluminum (NiAl) alloy, nickel-chromium-aluminum alloy, or nickel-chromium (NiCr) alloy. Specific contents of various components in various alloys have a relatively wide optional range in the present disclosure, can make reference to the prior art, and can be used in the present disclosure, which is not repeated herein.

In some preferred embodiments of the present disclosure, the surface roughness Ra of the self-lubricating protective coating is lower than 0.5 μm. The surface roughness of the self-lubricating protective coating is controlled in a suitable low range, which is more beneficial for rapid formation of a lubricating oil film on a friction interface.

In some preferred embodiments of the present disclosure, average microhardness of the self-lubricating protective coating is 400-900 HV_{0.3}.

HV_{0.3} refers to microscopic Vickers hardness under a testing load of 0.3 kgf (kilogram force).

Preferably in the present disclosure, the self-lubricating protective coating is capable of resisting 10 or more impacts under conditions that a magnetic bearing weight is not less than 1,000 kg and a rotational speed is not less than 5,000 rpm. The self-lubricating protective coating of the present disclosure can exhibit not obvious wear under 10 or more impacts under ultra-high loads and ultra-high rotational speeds, and offer an optimal long-term self-lubricating effect.

In the second aspect, the present disclosure provides a preparation method for a high-load-bearing and wear-resistant self-lubricating protective coating, including steps as follows:
S1, depositing a metal transition layer on a working surface of a substrate to be coated;
S2, preparing a porous ceramic material layer outside the metal transition layer, and controlling porosity of the ceramic material layer to be in gradient increasing distribution from inward to outward along a surface normal direction of the self-lubricating protective coating; and
S3, filling the pores of the ceramic material layer with lubricating oil.

Reference can be made to the prior art for depositing the metal transition layer in S1, for example, techniques such as ultrasonic flame spraying, arc spraying, and cold spraying can be used in the present disclosure as long as a target film layer can be obtained.

In some preferred embodiments of the present disclosure, the ceramic material layer is prepared using the thermal spray technique.

Further preferably, conditions of the thermal spraying include: a spraying distance of 80-130 mm, a current of 450-650 A, a voltage of 60-80 V, and a substrate temperature of 100-150° C. The present disclosure enables gradient distribution control over the porosity of the ceramic material layer by regulating and controlling keys, such as the spraying distance, current and voltage, in a thermal spraying process.

In some preferred embodiments of the present disclosure, the lubricating oil is filled using an impregnation process. The impregnation process includes, but is not limited to, vacuum impregnation, thermal impregnation and vacuum thermal impregnation, all of which can be used in the present disclosure.

Further preferably, conditions of impregnation include: an impregnation temperature of 50-200° C., a pressure of 1-100 Pa, single impregnation duration of 5-30 min, and 1-5 times of impregnation. In an impregnation process of the present disclosure, a penetration depth and an oil impregnation amount of the lubricating oil within the ceramic material layer can be controlled by regulating and controlling relevant parameters in the impregnation process, such as impregnation duration, temperature and pressure.

In some preferred embodiments of the present disclosure, the preparation method further includes: after preparing the ceramic material layer in S2, further performing grinding, so as to enable the final surface roughness Ra of the coating to be lower than 0.5 μm; and then performing S3. The present disclosure can control the thickness and the surface roughness of the prepared target coating through a grinding process.

In the third aspect, the present disclosure provides a high-load-bearing and wear-resistant self-lubricating protective coating, prepared by the preparation method for a high-load-bearing and wear-resistant self-lubricating protective coating of the second aspect. The self-lubricating protective coating of the third aspect is the same as the self-lubricating protective coating of the first aspect in structure and performance, which will not be repeated herein.

In the fourth aspect, the present disclosure provides a magnetic bearing, including an auxiliary bearing unit, where on an inner ring and/or an end surface of a contact area of the auxiliary bearing unit with a shaft, the high-load-bearing and wear-resistant self-lubricating protective coating of the first aspect or the high-load-bearing and wear-resistant self-lubricating protective coating of the third aspect is provided.

The self-lubricating protective coating of the present disclosure is particularly suitable for magnetic bearings, has certain toughness and damage tolerance, and will not generate damage such as obvious cracks or delamination under high-speed impacts of a large-mass shaft. Upon impact, the internal lubricating oil is extruded out and provides a friction-reduction effect, thus the long-term effect is favorable and stable. Furthermore, different types of lubricating media can be selected as the lubricating oil according to environmental changes, so as to satisfy lubrication requirements in different application scenarios, and meanwhile facilitate maintaining the usage effect thereof in different environments for a long time.

Examples of the present disclosure described in detail below are illustrative, merely used for explaining the present disclosure, but should not be construed as a limitation to the present disclosure.

### Example 1

In a magnetic bearing, a self-lubricating protective coating was coated on an inner ring and an end surface of a contact area (i.e., the corresponding bearing protecting sleeve) of an auxiliary bearing unit in contact with a shaft by a method as follows.
1. Firstly, a metal transition layer (specifically nickel-chromium alloy) with a thickness of 30 μm was deposited.
2. A gradient porous ceramic material layer (specifically an alumina-titania mixture, where titania accounted for 13 wt %) with a thickness of 200 μm was prepared through a thermal spraying process, where the number of pores was gradually and uniformly increased along a surface normal direction of the ceramic material layer, and a continuous variation range of porosity was 5%-35% (corresponding to a minimum value and a maximum value), and along the surface normal direction of the self-lubricating protective coating, an absolute value of a difference in porosity of two different adjacent gradients was 5%. Conditions of thermal spraying were as follows: a substrate temperature being 120° C., a spraying distance being 110 mm, adjusting a current to be 650 A, 611 A, 575 A, 541 A, 509 A, 479 A, and 450 A in sequence, at the same time, correspondingly adjusting a voltage to be 80 V, 76 V, 73 V, 70 V, 66 V, 63 V, and 60 V, and in this period, dividing the plurality of current and corresponding voltage parameters (i.e., spray power) in the above into seven gradients to realize gradient porosity control. In this process, the ceramic material layer having a specific gradient pore distribution was formed.
3. Through a grinding process, a thickness and surface roughness of the corresponding coating were controlled. Through the grinding process, the final surface roughness Ra of the coating was enabled to be lower than 0.5 μm, and the thickness of the ceramic material layer was maintained at 90 μm. A thickness ratio of the ceramic material layer to the metal transition layer was calculated to be 3:1.
4. Subsequently, a vacuum impregnation process was employed to fill the gradient porous ceramic material layer with lubricating oil (specifically methyl silicone oil), where conditions of the vacuum impregnation included: single impregnation duration of 10 min, an impregnation temperature of 100° C., a pressure of 30 Pa, and 3 times of impregnation, so as to control a penetration depth of the lubricating oil within the coating to be 90 μm. The penetration depth was calculated to be 100% of the thickness of the ceramic material layer.

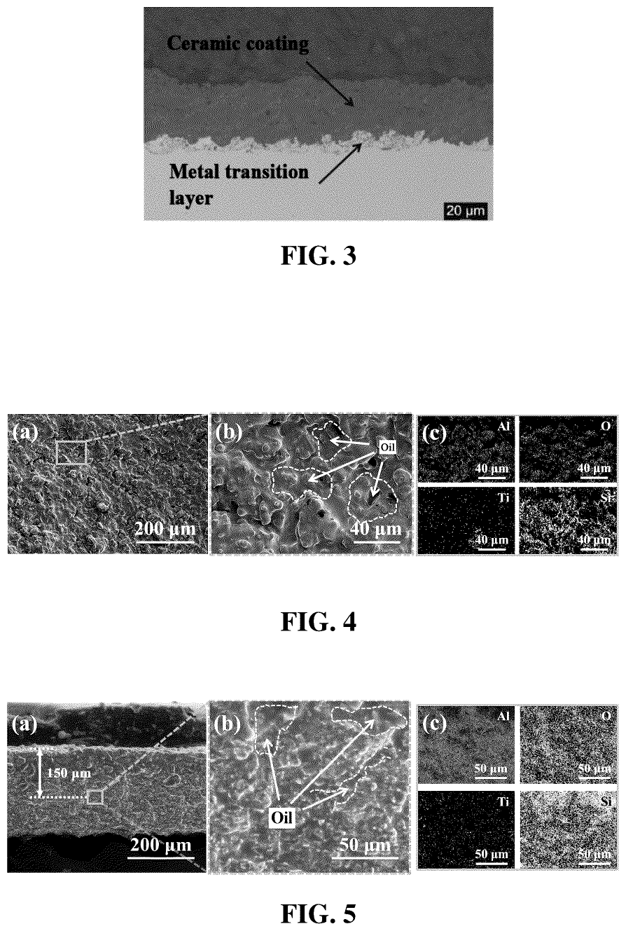

Microstructure of the coating obtained in Example 1 is as shown in FIG. 3. It can be seen that the coating is composed of the metal transition layer and the ceramic material layer, and the coating presents a typical layered structure. Moreover, the prepared self-lubricating protective coating was subjected to a cross-sectional topography test and analysis, and analysis results are as shown in FIG. 5. In conjunction with FIG. 5, it can be seen that the coating exhibited certain gradient distribution as seen from Si element distribution in the silicone oil, indirectly demonstrating that the number of pores of the self-lubricating protective coating was in gradient distribution, i.e., pores were present in the ceramic material layer, and the porosity was in increasing distribution from inward to outward along a normal direction. Due to the presence of an underlayer, i.e., the metal transition layer, the average bonding strength of the coating after five tests by a universal testing machine was 42 MPa, thus ensuring long-term service of the coating.

Certain porosity in the coating also ensures toughness and microhardness of the coating. The microhardness of the coating at 10 positions tested by a microhardness meter was listed in Table 1, and an average microhardness up to 659 HV_{0.3} was further obtained through calculation.

TABLE 1
Coating Microhardness

| | Test No. of Sample | | | | | | | | | | Average |
|---|---|---|---|---|---|---|---|---|---|---|---|
| | 1 | 2 | 3 | 4 | 5 | 6 | 7 | 8 | 9 | 10 | Microhardness |
| Microhardness | 633 | 718 | 629 | 664 | 741 | 592 | 680 | 584 | 659 | 692 | 659 |
| HV_{0.3} | | | | | | | | | | | |

The prepared self-lubricating protective coating was subjected to a surface topography test and analysis, and analysis results are shown in FIG. 4. It can be seen that the pores on the surfaces of the self-lubricating protective coatings were filled up with lubricating oil.

In a levitated rotor motor, the self-lubricating protective coating of the present disclosure was applied on an inner ring and an end surface of a contact area (i.e., the corresponding bearing protecting sleeve, referred to as a bushing for short) of an auxiliary bearing unit with a shaft. As shown in FIG. 2, after ten drop tests under an ultra-high load (magnetic bearing weight was 1,000 kg) and an ultra-high rotational speed (5,000 rpm), it can be seen that the magnetic bearing shaft and the auxiliary bearing bushing showed minimal wear after the ten drop tests.

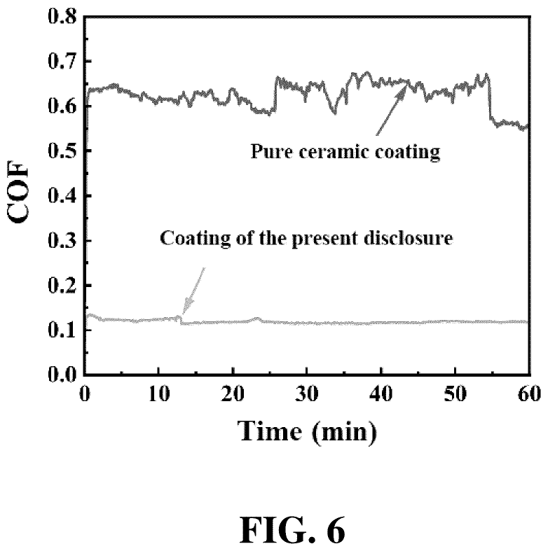

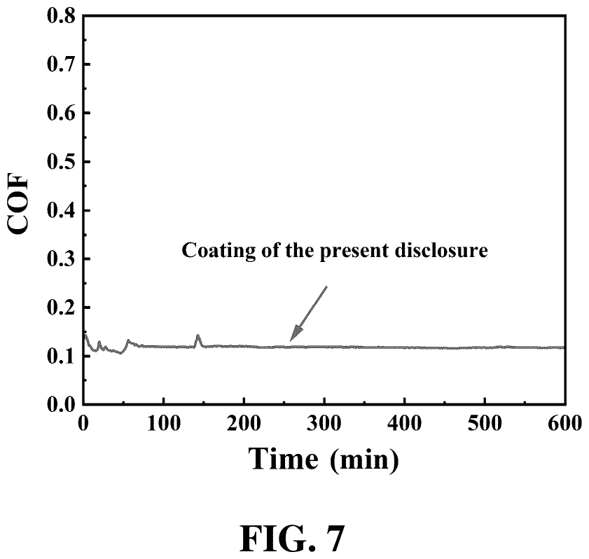

The present disclosure further performed tribological property test on the self-lubricating protective coating obtained in Example 1 having the above microstructural characteristics. A representative friction counterpart material YG6 (i.e., a tungsten-cobalt-based hard alloy material, commercially available) was selected to slide against target coatings for 1 h, where the target coatings included a control pure ceramic coating without applying lubricating oil (i.e., without the metal transition layer and without gradient porosity distribution) and the self-lubricating protective coating containing gradient lubricating oil distribution of the present disclosure. Results of coefficients of friction COF are as shown in FIG. 6, respectively. It can be seen from FIG. 6 that the coefficient of friction COF of the self-lubricating protective coating of the present disclosure was not more than 0.15, and compared with the pure ceramic coating with the coefficient of friction COF of 0.6-0.7, the self-lubricating protective coating prepared by the present disclosure had a better lubricating performance. Moreover, the self-lubricating protective coating of the present disclosure was also subjected to the same long-term friction test for 10 h, and results of the coefficient of friction are as shown in FIG. 7. It can be seen that the coefficient of friction COF is not more than 0.15 in the whole process, and is relatively stable, indicating that the self-lubricating protective coating of the present disclosure has a relatively good long-term lubricating performance.

### Example 2

It was carried out with reference to Example 1, except that amplitude gradient of uniform increase of the porosity within the ceramic material layer is different. Specifically, along the surface normal direction of the self-lubricating protective coating, the absolute value of the difference in porosity between two different adjacent gradients was 15%, and the maximum value and the minimum value of the porosity within the ceramic material layer were unchanged. Process conditions that needed to be adjusted for satisfying such porosity setting were: the spraying distance of 110 mm, the current of 650 A, 550 A, and 450 A, the voltage of 80 A, 70 A and 60 V, the substrate temperature of 120° C., and in this period, the plurality of current and corresponding voltage parameters (i.e., spray power) above were adjusted to realize gradient porosity control.

### Example 3

It was carried out with reference to Example 1, except that the amplitude of uniform increase of the porosity within the ceramic material layer was unchanged, the maximum value and the minimum value of the porosity were varied, and the porosity was in a range of 5%-25%.

### Example 4

It was carried out with reference to Example 1, except that the penetration depth of the lubricating oil within the ceramic material layer was adjusted to allow the penetration depth to be 80% of the thickness of the ceramic material layer. Process conditions that needed to be adjusted for satisfying the conditions were: the single impregnation duration of 10 min, the temperature of 100° C., the pressure of 50 Pa, and 1 time of impregnation.

### Example 5

It was carried out with reference to Example 1, except that the thickness of the metal transition layer was adjusted to be 25 μm, and the thickness ratio of the ceramic material layer to the metal transition layer was calculated to be 3.6:1.

### Comparative Example 1

It was carried out with reference to Example 1, except that the metal transition layer was not provided.

### Comparative Example 2

It was carried out with reference to Example 1, except that the porosity within the ceramic material layer was uniformly provided (not increased in a gradient), the porosity was 10%, and the pores were filled with the lubricating oil of the same penetration depth as that in Example 1. Process conditions that needed to be adjusted to satisfy such porosity setting were the spraying distance of 110 mm, the current of 611 A, the voltage of 76 V, and the substrate temperature of 120° C.

### Test Example

The coatings obtained in Examples 2-5 and Comparative Examples 1-2 were subjected to the same property tests as in Example 1, and results are listed in Table 2. The number of tolerable impacts under identical ultra-high load and ultra-high rotational speed refers to corresponding number when an obvious wear phenomenon of at least one of obvious coating delamination, grooving, adhesion and the like occurs to surfaces of the shaft and the auxiliary bearing bushing after multiple drop tests under identical ultra-high load and ultra-high rotational speed, and is an average value of multiple groups of data.

TABLE 2
Property Test Results of Coatings Obtained in
Examples 1-5 and Comparative Examples 1-2

| | Average | Number of Tolerable | Value of Average | |
|---|---|---|---|---|
| | Bonding | Impacts under Identical | Coefficient of | |
| | Strength with | Ultra-High Load and | Friction after 10 | Average |
| Property | Substrate, | Ultra-High Rotational | h of Long-term | Microhardness, |
| Index | MPa | Speed (average value) | Friction | HV_{0.3} |
| Example 1 | 42 | 18 | 0.12 | 659 |
| Example 2 | 38 | 14 | 0.12 | 630 |
| Example 3 | 45 | 12 | 0.15 | 686 |
| Example 4 | 41 | 11 | 0.13 | 642 |
| Example 5 | 43 | 13 | 0.12 | 662 |
| Comparative | 26 | 3 | 0.12 | 660 |
| Example 1 | | | | |
| Comparative | 46 | 2 | 0.21 | 782 |
| Example 2 | | | | |

As can be seen from the above results, compared with the comparative examples, the self-lubricating protective layer obtained in the solutions of the examples of the present disclosure offers high bonding strength with the substrate, can achieve excellent lubrication, wear resistance and material compatibility, and can withstand 10 or more impacts of the magnetic bearing under high speeds and high loads with virtually no wear on the shaft or the auxiliary bearing of the magnetic bearing. Moreover, long-term service of the self-lubricating protective coating is ensured, and toughness and microhardness of the self-lubricating protective coating are guaranteed, and repeated use is enabled.

Further, according to Example 1 and Examples 2-5, it can be seen that by adopting the preferred solutions of the present disclosure, more impacts can be tolerated under identical ultra-high load and ultra-high rotational speed, which is more beneficial to prolong the service lifetime of high-power magnetic bearings.

Preferred embodiments of the present disclosure are described in detail above, but the present disclosure is not limited thereto. Within the scope of the technical concept of the present disclosure, a number of simple modifications can be made to the technical solutions of the present disclosure, including combining various technical features in any other suitable ways, and these simple modifications and combinations should also be regarded as contents disclosed in the present disclosure, and fall within the scope of the present disclosure.

1. A high-load-bearing and wear-resistant self-lubricating protective coating, comprising a metal transition layer and a ceramic material layer provided in sequence, wherein the ceramic material layer is provided with a plurality of pores, a porosity of the ceramic material layer is in gradient increasing distribution from inward to outward along a surface normal direction of the self-lubricating protective coating, and the pores of the ceramic material layer are filled with lubricating oil.

2. The high-load-bearing and wear-resistant self-lubricating protective coating according to claim 1, wherein the porosity of the ceramic material layer is 5%-35%, and/or the ceramic material layer is oxide ceramic.

3. The high-load-bearing and wear-resistant self-lubricating protective coating according to claim 1, wherein an increase in the amplitude of the porosity of the ceramic material layer satisfies that along the surface normal direction of the self-lubricating protective coating, an absolute value of a difference in the porosity between two different adjacent gradients is 5%-15%.

4. The high-load-bearing and wear-resistant self-lubricating protective coating according to claim 1, wherein a penetration depth of the lubricating oil within the ceramic material layer is 60%-100% of a thickness of the ceramic material layer, and/or the penetration depth of the lubricating oil within the ceramic material layer is 50-300 μm.

5. The high-load-bearing and wear-resistant self-lubricating protective coating according to claim 1, wherein a thickness of the ceramic material layer is 50-300 μm, and a thickness of the metal transition layer is 20-60 μm; and/or a thickness ratio of the ceramic material layer to the metal transition layer is (2.5-5):1.

6. The high-load-bearing and wear-resistant self-lubricating protective coating according to claim 1, wherein a material of the ceramic material layer comprises at least one selected from alumina, titania, zirconia, and chromia; and/or a material of the metal transition layer is selected from MCrAlY alloy and/or an aluminum alloy, wherein M in the MCrAlY alloy is Ni, Co, Fe or any combination thereof, and the aluminum alloy comprises at least one selected from nickel-aluminum alloy, nickel-chromium-aluminum alloy, and nickel-chromium alloy.

7. The high-load-bearing and wear-resistant self-lubricating protective coating according to claim 1, wherein a material of the ceramic material layer is selected from a mixture of alumina and titania or a mixture of chromia and titania, and/or the surface roughness Ra of the self-lubricating protective coating is lower than 0.5 μm.

8. The high-load-bearing and wear-resistant self-lubricating protective coating according to claim 1, wherein an average microhardness of the self-lubricating protective coating is 400-900 HV_{0.3}, and/or the self-lubricating protective coating is capable of resisting 10 or more impacts under conditions that a magnetic bearing weight is not less than 1,000 kg and a rotational speed is not less than 5,000 rpm.

9. A preparation method for a high-load-bearing and wear-resistant self-lubricating protective coating, comprising steps of: S1, depositing a metal transition layer on a working surface of a substrate to be coated; S2, preparing a ceramic material layer provided with a plurality of pores outside the metal transition layer, and controlling a porosity of the ceramic material layer to be in gradient increasing distribution from inward to outward along a surface normal direction of the self-lubricating protective coating; and S3, filling the pores of the ceramic material layer with lubricating oil.

10. The preparation method for a high-load-bearing and wear-resistant self-lubricating protective coating according to claim 9, wherein the ceramic material layer is prepared using a thermal spray technique, wherein conditions of the thermal spraying comprise: a spraying distance of 80-130 mm, a current of 450-650 A, a voltage of 60-80 V, and a substrate temperature of 100-150° C.; and/or the lubricating oil is filled using an impregnation process, wherein conditions of impregnation comprise: an impregnation temperature of 50-200° C., a pressure of 1-100 Pa, single impregnation duration of 5-30 min, and 1-5 times of impregnation.

11. The preparation method for a high-load-bearing and wear-resistant self-lubricating protective coating according to claim 9, wherein the preparation method further comprises: after preparing the ceramic material layer in S2, further performing grinding to make a final surface roughness Ra of the coating lower than 0.5 μm; and then performing S3.

12. A magnetic bearing, comprising an auxiliary bearing unit, wherein the high-load-bearing and wear-resistant self-lubricating protective coating according to claim 1 is provided on an inner ring and/or an end surface of a contact area of the auxiliary bearing unit with a shaft.

13. The high-load-bearing and wear-resistant self-lubricating protective coating according to claim 2, wherein an increase in the amplitude of the porosity of the ceramic material layer satisfies that along the surface normal direction of the self-lubricating protective coating, an absolute value of a difference in the porosity between two different adjacent gradients is 5%-15%.

14. The magnetic bearing according to claim 12, wherein the porosity of the ceramic material layer is 5%-35%, and/or the ceramic material layer is oxide ceramic.

15. The magnetic bearing according to claim 12, wherein an increase in the amplitude of the porosity of the ceramic material layer satisfies that along the surface normal direction of the self-lubricating protective coating, an absolute value of a difference in the porosity between two different adjacent gradients is 5%-15%.

16. The magnetic bearing according to claim 12, wherein a penetration depth of the lubricating oil within the ceramic material layer is 60%-100% of a thickness of the ceramic material layer, and/or the penetration depth of the lubricating oil within the ceramic material layer is 50-300 μm.

17. The magnetic bearing according to claim 12, wherein a thickness of the ceramic material layer is 50-300 μm, and a thickness of the metal transition layer is 20-60 μm; and/or a thickness ratio of the ceramic material layer to the metal transition layer is (2.5-5):1.

18. The magnetic bearing according to claim 12, wherein a material of the ceramic material layer comprises at least one selected from alumina, titania, zirconia, and chromia; and/or a material of the metal transition layer is selected from MCrAlY alloy and/or an aluminum alloy, wherein M in the MCrAlY alloy is Ni, Co, Fe or any combination thereof, and the aluminum alloy comprises at least one selected from nickel-aluminum alloy, nickel-chromium-aluminum alloy, and nickel-chromium alloy.

19. The magnetic bearing according to claim 12, wherein a material of the ceramic material layer is selected from a mixture of alumina and titania or a mixture of chromia and titania, and/or the surface roughness Ra of the self-lubricating protective coating is lower than 0.5 μm.

20. The magnetic bearing according to claim 12, wherein an average microhardness of the self-lubricating protective coating is 400-900 HV_{0.3}, and/or the self-lubricating protective coating is capable of resisting 10 or more impacts under conditions that a magnetic bearing weight is not less than 1,000 kg and a rotational speed is not less than 5,000 rpm.
